(19) United States
(12) Patent Application Publication
(10) Pub. No.: US 2016/0266665 A1
(43) Pub. Date: Sep. 15, 2016

(54) MULTI-PURPOSE WRITING DEVICE

(71) Applicant: OSAMA S.P.A., Mombretto di Mediglia (MI) (IT)

(72) Inventor: Koici TSCHANG, Milano (MI) (IT)

(21) Appl. No.: 14/644,047

(22) Filed: Mar. 10, 2015

(51) Int. Cl. G06F 3/0354; G06F 3/041

(52) U.S. Cl. CPC G06F 3/03545; G06F 3/0416

(57) ABSTRACT

A multi-purpose writing device comprises a device main body including a pressure or snap engageable cap, a writing tip adapted to contact without damaging a touch screen and an inner erasable ink vessel.

### BACKGROUND OF THE INVENTION

The present invention relates to a multiple-purpose writing device.

As is known, electronic devices including a so-called touch screen, allowing a user to interoperate with a graphic interface by his/her fingers or other specifically designed elements, are at present increasingly used.

Said electronic devices comprise the so-called smart phones, having comparatively small touch screens.

In order to operate on said small touch screens, stylus element or other articles such as a writing pen are frequently used, and such a use is sometimes an indispensable one.

However, a stylus may not be easily available, whereas a normal ball pen or other conventional writing instrument may disadvantageously damaging the touch screen and accordingly its use is not an operatively safe one.

### SUMMARY OF THE INVENTION

The aim of the present invention is to provide a writing device, such as a ball pen or the like, which may be used on a touch screen without damaging said screen.

A further object of the present invention is to provide such a device which may be made using easily commercially available elements and materials like plastics material or soft rubber material and which, moreover, are very competitive from a mere economic standpoint.

Yet another object of the present invention is to provide such a multi-purpose writing device which is very reliable and safe in operation.

According to one aspect of the present invention, the above mentioned aim and objects, as well as yet other objects, which will become more apparent hereinafter, are achieved by a multiple-purpose writing device, characterized in that said device comprises a main body including a pressure or snap engageable cap, said main body comprising a writing tip and an inner ink vessel.

Said writing device is of an erasable ink type. The cap comprises, at an end portion thereof opposite to its inlet part, or mouth, a tactile tip portion adapted to be used on a touch screen or a like device.

### BRIEF DESCRIPTION OF THE DRAWINGS

Further characteristics and advantages of the present invention will become more apparent hereinafter from the following disclosure of a preferred, though not exclusive, embodiment of the invention which is illustrated, by way of an indicative but not limitative, example, in the accompanying drawings, where:

FIG. 1 shows a writing device with a closed cap, such as a touch screen stylus in a use or in a rest condition thereof;

FIG. 2 is a further view of the device of FIG. 1, with the cap removed therefrom, to be used as a conventional ball pen;

FIG. 3 shows another writing device, with a closed cap, such as a touch screen stylus in a use or in a rest condition thereof; and

FIG. 4 is a further view of the device of FIG. 3, with the cap being detached, for use as a conventional ball pen.

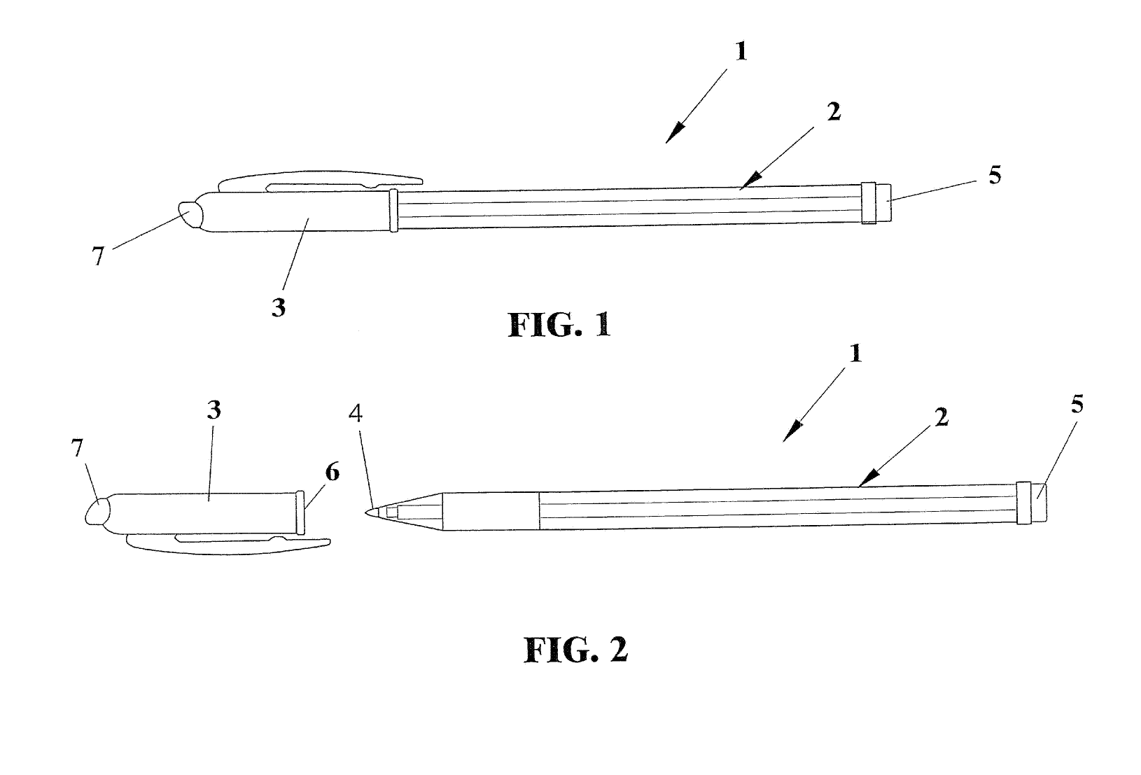

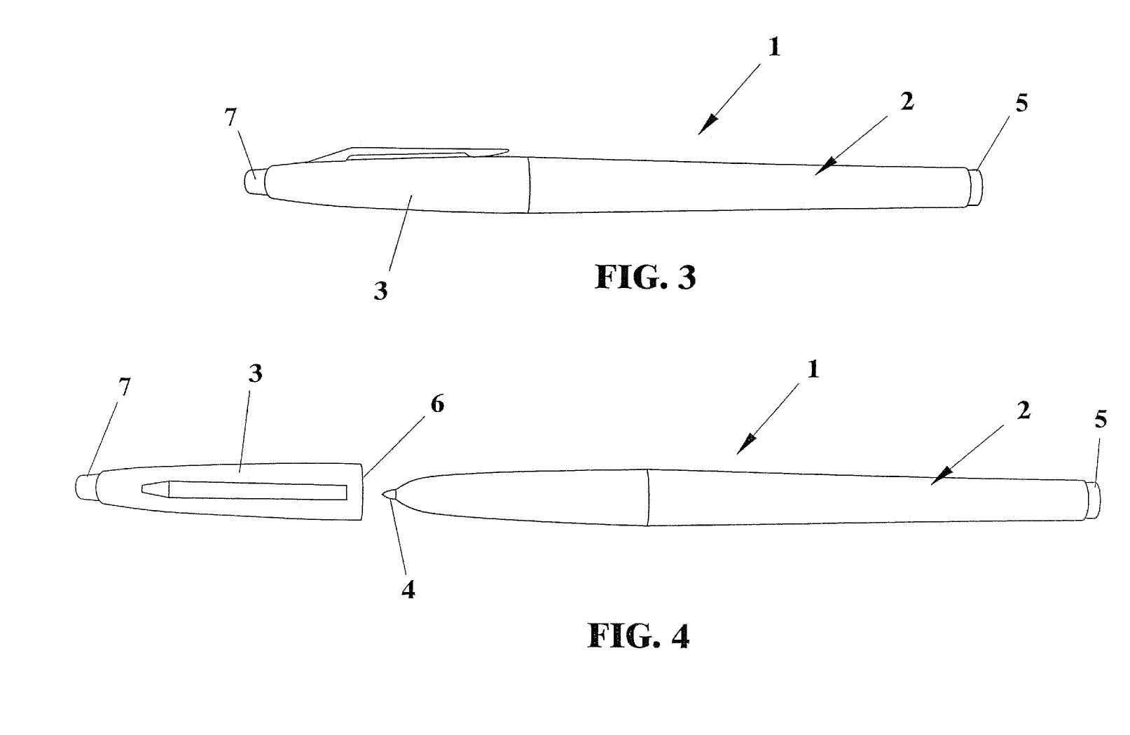

### DESCRIPTION OF THE PREFERRED EMBODIMENTS

With reference to the number references of the above mentioned figures, the multi-purpose writing device according to the present invention, which has been generally indicated by the reference number 1, comprises a main body 2 including a pressure or snap engageable cap 3.

Said main body 2 comprises a writing tip portion 4 and an inner ink vessel or tank, not shown in the drawings.

Advantageously, the writing device is of an erasable ink type.

Said main body 2 comprises, at the end portion thereof opposite to the writing tip 4, an erasing element 5, to be used for removing ink provided by the writing tip.

According to the present invention, said cap 3 comprises, at the end portion thereof opposite to its mouth portion 6, a tactile tip 7 which may be used on a touch screen or the like device

Said tactile tip 7 has a convex configuration and it is made of such a material not damaging the surface of the touch screen contacted or touched by said tip 7.

The writing device according to the present invention may be used, with the cap applied to the main body, directly on the touch screen, to facilitate a digit or symbol and sign formation while providing, if the touch screen allows this, a digital type of writing.

Upon removing the cap 3, the multi-purpose device according to the present invention may also be used as a conventional erasable ball pen.

It has been found that the invention fully achieves the intended aim and objects.

In fact, the invention has provided a multi-purpose writing device, which may also be used as an erasable ball pen, for operating on a touch screen in a very efficient manner and without damaging the latter.

Thus, a use of the inventive device on a touch screen, instead of using the hand fingers, facilitates the digit and sign formation while preventing the touch screen from being stained or damaged.

In practicing the invention, the used materials, as well as the contingent size and shapes, can be any depending on requirements.

1. A multi-purpose writing device, characterized in that said device comprises a device main body (2) including a pressure or snap engageable cap (3), a writing tip (4) and an inner ink vessel (5).

2. A multi-purpose writing device, according to claim 1, characterized in that said writing device is of an erasable ink type.

3. A multi-purpose writing device, according to claim 1, characterized in that said main body (2) comprises, at an end portion thereof opposite to the writing tip (4), and erasing element (5) for removing ink deposited by the writing tip (4).

4. A multi-purpose writing device, according to claim 1, characterized in that said cap (3) comprises, at an end portion thereof opposite to a mouth portion (6) thereof, a tactile or touching tip (7) adapted to be used on a touch screen or a like device.

5. A multi-purpose writing device, according to claim 1, characterized in that said tactile tip (7) has a convex configuration thereby not damaging the surface of the touch screen touched by said tip.

6. A multi-purpose writing device, according to claim 1, characterized in that said device may be used, with the cap applied to the main body, directly on a touch screen, thereby facilitating a digit or sign formation to perform a digital writing.

7. A multi-purpose writing device, according to claim 1, characterized in that said device, upon removing said cap (3), may be used as an erasable ball pen.

8. A multi-purpose writing device, according to claim 1, characterized in that said tip (7) is made either of a plastics material or a soft rubber material, preventing a surface of the screen touched by said tip from being damaged.
